(19) United States
(12) Patent Application Publication
(10) Pub. No.: US 2024/0399240 A1
(43) Pub. Date: Dec. 5, 2024

(54) SCRAMBLED CUBE GAME OR PUZZLE

(71) Applicant: C-U-B-E-S L.L.C., Spokane, WA (US)

(72) Inventor: Jacob B. Goettsche, Spokane, WA (US)

(73) Assignee: C-U-B-E-S L.L.C., Spokane, WA (US)

(21) Appl. No.: 18/326,776

(22) Filed: May 31, 2023

(51) Int. Cl. A63F 9/00; A63F 13/52; A63F 13/80

(52) U.S. Cl. CPC A63F 9/0098; A63F 13/52; A63F 13/80

(57) ABSTRACT

Briefly, embodiments of a game or puzzle, such as involving arranging labels on a cube-like structure, for example, are described.

### BACKGROUND

### Field

This disclosure relates to a game or puzzle, such as one in the form of a cube or a cube-like structure.

### Information

A variety of word games or puzzles exist that involve placement of words in a specific spatial relationship to one another, one well-known example being a crossword puzzle. For entertainment, for mental exercise, and/or for other reasons, new varieties of word games continue to be sought.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is an illustration of a schematic diagram showing an embodiment of a cube or cube-like game or puzzle in accordance with claimed subject matter.

FIG. 2 is an illustration of a schematic diagram showing an embodiment of a computing and/or communications network that includes several computing devices able to mutually communicate via the computing and/or communications network;

FIG. 3 is an image illustrating a display of Unreal Engine 5.1, available from Epic Games;

FIGS. 4 to 10 are differing illustrations of a schematic diagram showing an embodiment of a cube or cube-like game or puzzle in accordance with claimed subject matter.

FIGS. 11 and 12 are illustrations of schematic diagrams showing another embodiment of a cube or cube-like game or puzzle in accordance with claimed subject matter.

### DETAILED DESCRIPTION

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Furthermore, structural and/or other changes may be made without departing from claimed subject matter. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents. Further, it is to be understood that other embodiments may be utilized. Also, embodiments have been provided of claimed subject matter and it is noted that, as such, those illustrative embodiments are inventive and/or unconventional; however, claimed subject matter is not necessarily limited to embodiments provided primarily for illustrative purposes. Thus, while advantages have been described in connection with illustrative embodiments, claimed subject matter is inventive and/or unconventional for additional reasons not expressly mentioned in connection with those embodiments. In addition, references throughout this specification to “claimed subject matter” refer to subject matter intended to be covered by one or more claims and are not necessarily intended to refer to a complete claim set, to a particular combination of claim sets (e.g., method claims, apparatus claims, etc.), or to a particular claim.

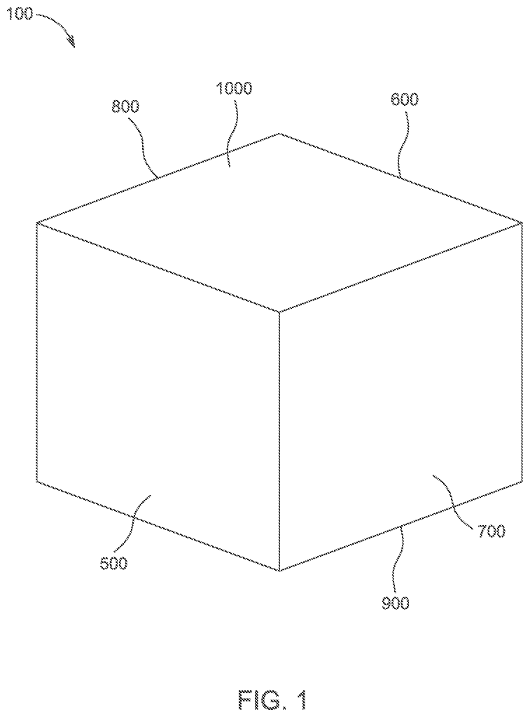

Referring to FIG. 1, an embodiment 100 of a physical cube-like structure is shown having six faces, 500, 600 (not shown), 700, 800 (not shown), 900 (not shown) and 100. For convenience, the term “cube” is used hereinafter to refer to embodiment 100 without loss of generality or understanding regarding a physical cube-like structure.

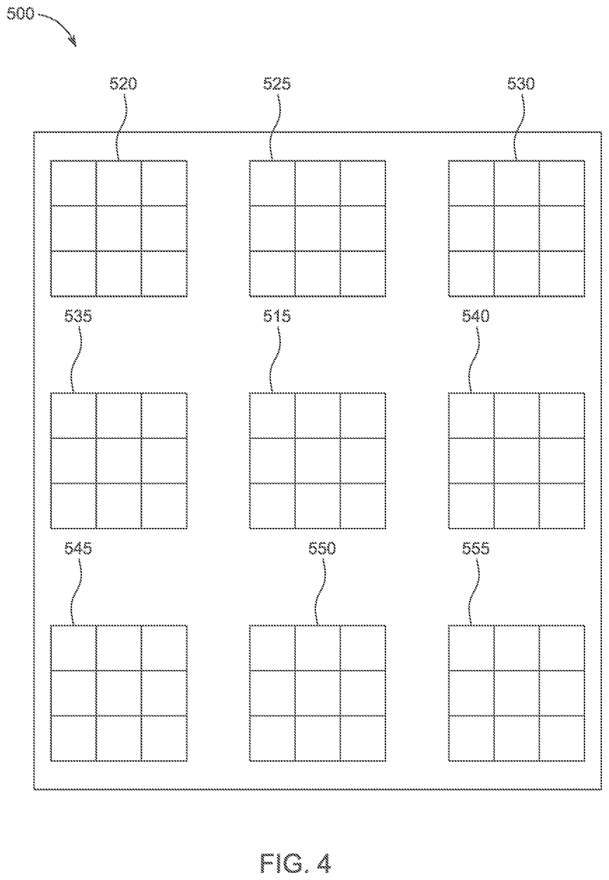

One face of cube 100 is shown in FIG. 4. As depicted, a respective face, such as 500, for example, has the physical structure shown. Thus, a face, such as 500, has a square cell within a square cell structure. That is, face 500, for example, comprises 9 three by three outer or large cells, designated 515, 520, 525, 530, 535, 540, 545, 550, and 555. However, any outer or large cell, such as center large cell 515, for example, comprises a three-by-three structure of nine inner or small cells, in this example embodiment. This face might, for example, be described as a set of three by three micro and macro multilateral grids. Cube embodiment 100 may be employed with a separate set of physical labels, which may be attached to positions, for example, on one of the faces of cube 100, such as face 500, to play a word game or puzzle in accordance with claimed subject matter. It is, of course, not intended that claimed subject matter necessarily be limited to illustrative embodiments, such this illustrative embodiment. For example, other “square within a square” structures, such as two by two, four by four, etc., may be employed in other embodiments.

Continuing with this illustration, however, other faces of cube 100 have the same or a substantially similar structure as shown in FIG. 4. Thus, any face of cube 100 comprises a nine-by-nine square structure of small cells (e.g., a set of three by three macro and micro multilateral grids). It is noted, again, however, that FIG. 1 merely provides an illustrative embodiment in accordance with claimed subject matter and it is not intended that claimed subject matter necessarily be limited to illustrative embodiments.

However, continuing with this illustration, as mentioned, a physical cube structure is employed in one embodiment as the basis for a word game or word puzzle in which topics, categories, and/or subcategories may be arranged on the faces of cube embodiment 100 in patterns using physical labels for the cells on the cube faces, as described in more detail. It is noted that throughout this description the terms puzzle and game may be used interchangeably without any loss in generality, which is what is intended. A game may be played so that the patterns arranged on the faces of the cube relate to selected topics, selected categories and/or selected subcategories in a manner that takes advantage of physical symmetries of the structure of the cube and/or cube faces. One way to think of a puzzle or game in accordance with claimed subject matter is as a scrambled arrangement of topics, categories and/or subcategories on a cube structure in which the puzzle to solve is to unscramble the arrangement of topics, categories and/or subcategories. That is, a player may rearrange the topics, categories and/or subcategories to align with the physical symmetries of the cube structure and/or the cube faces, as described in more detail below for an embodiment.

Thus, an embodiment of an apparatus for use in playing a word game, for example, in which the game may comprise arranging selected physical category labels from a group of physical category labels and arranging selected physical subcategory labels from a group of physical subcategory labels so as to take selected positions on a cube-like structure having six cube-like faces. Such an embodiment may comprise a cube-like physical structure having six cube-like faces in which a respective cube-like face may correspond with a respective selected topic in a particular arrangement related to a symmetrical structure between the cube-like faces so as to contrast the selected topics in a manner that at least relates to the symmetrical structure between the cube-like faces with respect to the cube-like structure. As a non-limiting example, topics for faces 500 and 600 may be contrasted. Likewise, topics for faces 700 and 800. Furthermore, topics for faces 900 and 100) may also be contrasted.

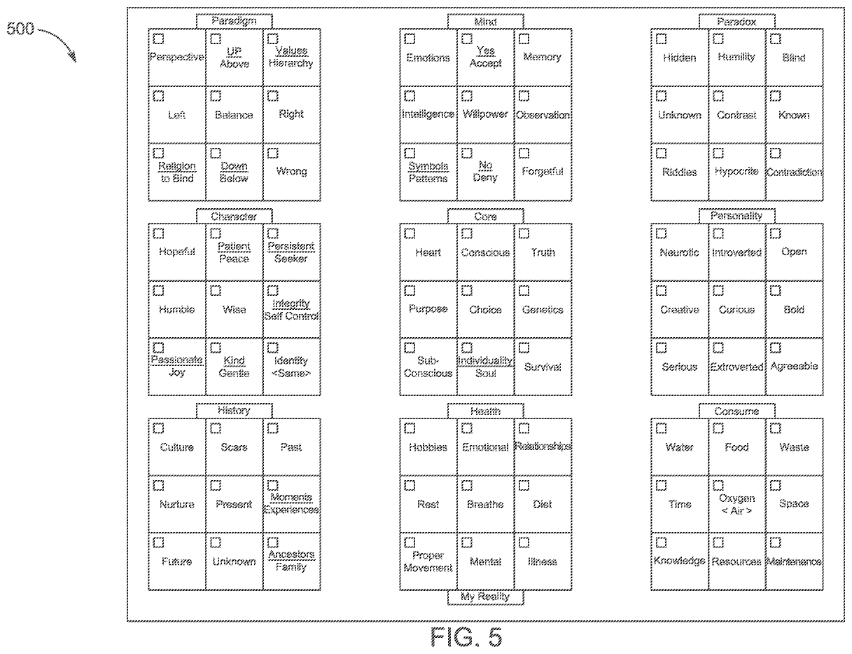

Furthermore, for such an embodiment, one respective cube-like face of the six cube-like faces may have a structure of a number of large cells such that the number of large cells are able to be arranged in a square structure on the one respective cube-like face, in which the large cells of the one respective cube-like face respectively may have a space for placement of a physical category label in which the category may comprise a category within the respective selected topic of the one respective cube-like face, and the number of different physical labels for the number of different categories within the respective selected topic of the respective one cube-like face may correspond to the number of large cells such that the selected categories are to be arranged in the square structure so as to contrast the different selected categories of the respective selected topic of the one respective cube-like face in a manner that at least relates to the symmetry of the large cell square structure of the one respective cube-like face. Again, as a non-limiting example, referring to FIG. 4 and then to FIG. 5, a topic for a face, as shown in FIG. 5, may comprise “My Reality.” Thus, for such a face, as depicted in FIG. 4, a three-by-three arrangement of nine large cells are shown. FIG. 5 shows the three-by-three arrangement of nine large cells with an arrangement of selected categories via use of physical labels. Thus, the illustrative embodiment of FIG. 5 includes the following categories: Paradigm, Mind, Paradox, Character, Core, Personality. History. Health and Consume. As explained in more detail later, these categories are intended to comprise categories within the topic “My Reality” and are arranged on face 500 in a manner intended to compare and contrast the particular categories.

Likewise, for such an embodiment, one respective large cell of the number of large cells may be intended to have a selected physical category label in which the selected category may comprise a category within the respective selected topic of the one respective cube-like face, the one respective large cell intended to have a number of small cells arranged in a square structure within the one respective large cell, in which the small cells of the one respective large cell respectively may have a space for placement of a physical subcategory label in which the subcategory comprises a subcategory within the selected category of the one respective large cell. The number of different physical labels for the number of different subcategories within the respective selected category may correspond to the number of small cells such that the subcategories are to be arranged in the square structure so as to contrast the different selected subcategories within the selected category in a manner that, similar to the large cells, at least relates to the symmetry of the small cell square structure of the one respective large cell. Thus, again, referring to the illustrative embodiment of FIG. 5, the large cell for the category “Consume” includes the following subcategories: Water. Food. Waste, Time. Oxygen (or Air), Space, Knowledge. Resources and Maintenance. As explained in more detail later, these subcategories are intended to comprise subcategories within the category “Consume” and are arranged in a three-by-three small cell arrangement within a large cell in a manner intended to compare and contrast the particular subcategories.

To make the manner of solving the puzzle or playing the game clearer, more details of a specific embodiment shall now be described as an illustration. However, again, as mentioned, it is to be understood that claimed subject matter is not intended to necessarily be limited to illustrative embodiments, such as the those discussed above and/or below. So, in an embodiment, as indicated, six topics may respectively be associated with the six cube faces.

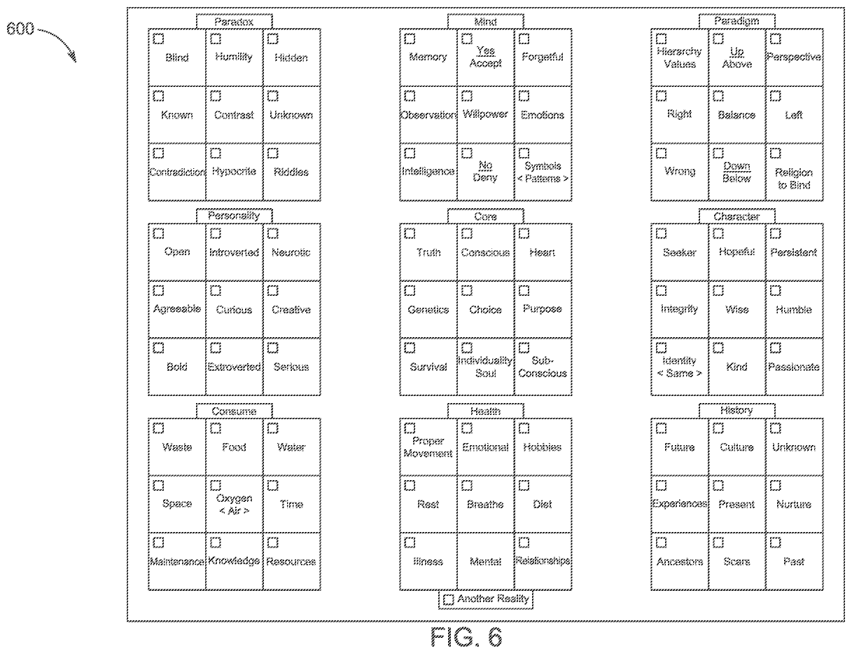

For example, again, referring to FIG. 5, the topic of face 500 may comprise “My Reality.” How that topic is understood will become clearer as a description of categories and subcategories takes place in more detail below. However, for now, to take advantage of the symmetrical nature of the cube structure, an opposing face to face 500 is face 600. Thus, the topic of face 600 is “Another Reality.” shown by FIG. 6. It is noted, and as shall become clearer. “My Reality” and “Another Reality” may be understood as mirror images of one another, again, taking advantage of the physical symmetry of the cube faces with respect to the cube structure, for example. However, in another embodiment, instead. “Another Reality” may involve play with another person who may attempt his or her own arrangement on face 600 of the categories and subcategories, in the manner previously described, for example.

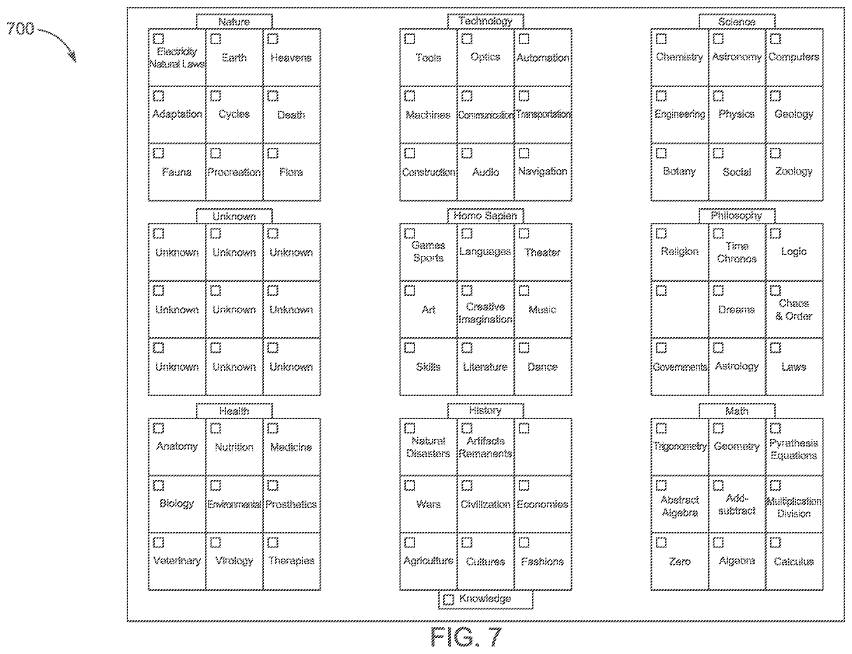

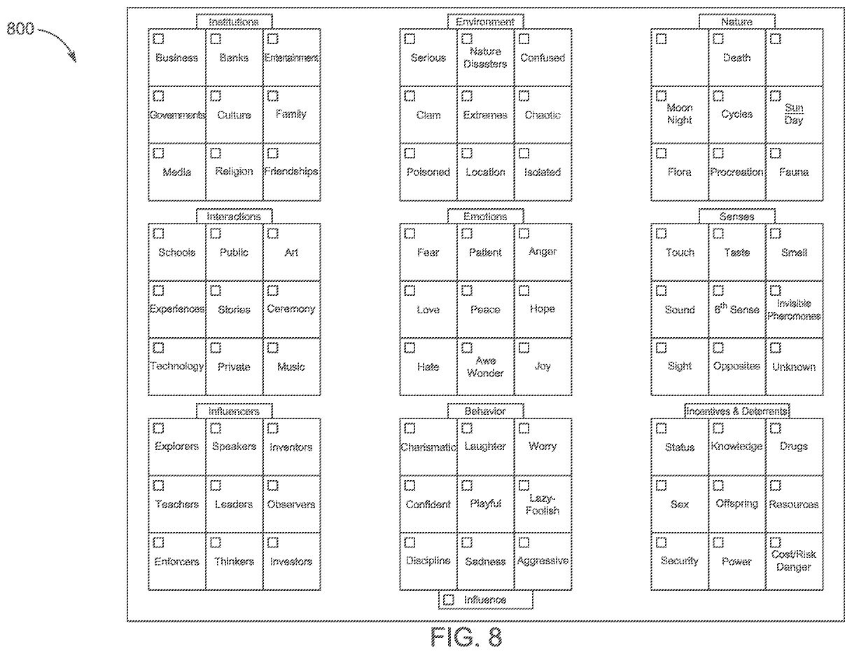

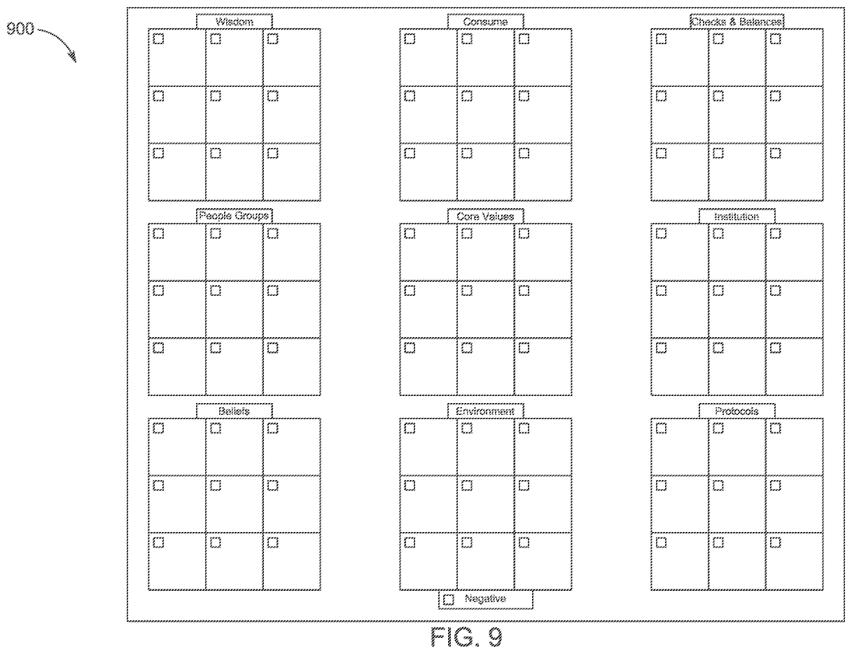

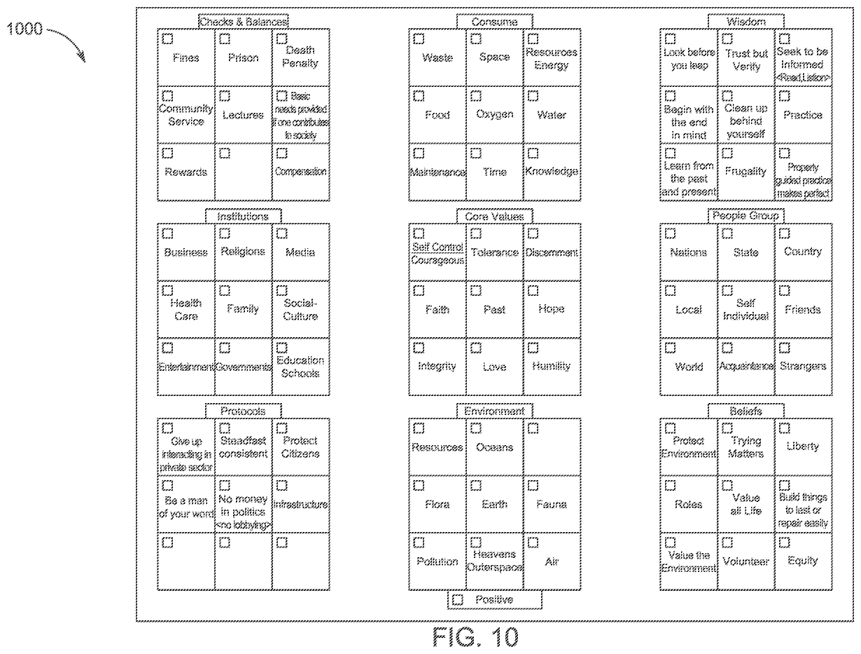

Continuing with topics, “Knowledge” may be the topic of face 700, shown by FIG. 7, with the topic of its opposing face 800 being “Influence,” shown by FIG. 8. For this particular embodiment, the remaining faces include the face immediately adjacent to the ground, 900, shown by FIG. 9, and its opposing face 1000, shown by FIG. 10. Face 900 may have the topic “Negative” (hence, for example, the physical association with the cube bottom) and face 1000 may have the topic “Positive.” (hence, for example, the physical association with the cube top). Thus, again, for this embodiment, the six topics for opposing cube faces, taken two at a time, relate in a manner that reflects a type of physical symmetry in the arrangement of the faces of the cube.

Although claimed subject matter is not necessarily limited in scope in this respect, these particular topics are chosen as described in the book “Connect” whose author is the inventor of claimed subject matter. The book “Connect” discusses “Cube Philosophy” and what is constructed through an arrangement of physical labels in cells, such as previously described for example and illustrated by FIG. 4 in an embodiment, of a cube-like structure 100, such as previously described, for example, and illustrated by FIG. 1, in the book “Connect,” referred therein as a “Connection Cube.” Thus, an embodiment of a game or puzzle in accordance with claimed subject matter may be referred to as a “Connection Cube.” As described in “Connect,” constructing an arrangement of particular topics, categories and/or subcategories allows a person playing the game or solving the puzzle to make “connections” by seeing relationships between the topics, categories and/or subcategories that may be reflected in the placement of physical labels on a cube face and/or through comparison of label placements for other topics, categories and/or subcategories on other cube faces. The book “Connect” is included as an appendix to this patent specification and, likewise, is herein incorporated by reference in this patent application in its entirety. The book “Connect” is also available via the World Wide Web at the website, www.CubePhilosophy.com.

For example, how the six named topics for this example embodiment are arranged on the six faces is meant to contrast the topics in a manner to reflect the structural symmetry of opposing faces around a cube. For example, “Positive” is opposite “Negative” as topics, and, therefore, are positioned opposite one another on the faces of embodiment 100. Furthermore, as shall be described, the arrangements of physical labels on the faces for “Positive” and “Negative” may be, in effect, at least approximate mirror images of one another, which, again, employs the spatial symmetry of the cube to relate, topics, categories and/or subcategories. Likewise. “My Reality” is placed opposite “Another Reality,” for similar reasons, etc.

Now, again referring to FIG. 5, it depicts one arrangement of categories and/or subcategories for one embodiment of a cube face, here, face 500 with the topic “My Reality.” Face 50), in this embodiment, as was mentioned, includes nine three by three large cells in which any large cell of the nine includes a three by three arrangement of small cells, so that face 500 is a nine by nine arrangement of 81 small cells. Addressing the nine large cells of face 500, depicted are nine categories with a respective category associated with a respective large cell.

As shown in FIG. 5, the nine categories are: Paradigm, Mind. Character, History, Core, Health. Paradox, Personality and Consume. As described in “Connect,” these are categories that are identified as within and, in essence, making up the topic. “My Reality.” Again, however, claimed subject matter is not necessarily limited in scope to this particular embodiment. For example, a different topic might be associated with this cube face in another embodiment. Likewise, other categories might have been chosen as within and/or descriptive of the topic “My Reality,” in another embodiment; nonetheless, for purposes of playing the game in accordance with this embodiment, the relationships of these particular categories are described in “Connect.” Furthermore, as depicted in FIG. 5, the nine categories have a particular arrangement on face 500. As illustrated previously in connection with FIG. 4, positions on face 500 may be described as center 515, top 525, bottom 550, left 535, right 540, and corners. Likewise, the corners may be described as top left 520, top right 530, bottom left 545 and bottom right 555.

These positions within a large cell may be given significance that relates to one position relative to another position on a cube face. For example, the center position may be understood as being the most important or most fundamental category. Hence, as described below, the category “Core” may be assigned to that position. Likewise, top, bottom, left and right may be understood to relate directly to the center, so that categories that relate directly to the “Core” category may be positioned in these locations; whereas, the four corners may be understood to be less directly related to the center, so that categories that relate less directly to the “Core” category may be positioned in these locations. The relationship of these positions may have other associations as part of the game or puzzle in an embodiment. Rationales for particular positions are described by example for this embodiment in the book “Connect.” For example, a position like “top” may have an association such as “best” or “most” and a position like “bottom” may have an association such as “worst” or “least.” Again, claimed subject matter is not necessarily limited in scope to these particular illustrative associations between positions and topics, categories and/or subcategories.

Nonetheless, this particular arrangement of these categories is discussed in the book “Connect.” However, part of the puzzle or game is for a person playing the game to construct his or her own arrangement of the nine categories on face 500. Therefore, in an embodiment, physical category labels for Paradigm. Character, History, Core, Health, Paradox. Personality and Consume may be arranged differently. How these categories may be arranged involves reasoning, analogies, experiences, etc. applied by the person playing the game or solving the puzzle through application of that person's understanding of these categories while also attributing significance to particular positions on the cube face so that how the categories relate to one another also relates to the positions of the particular categories on the cube face. One particular example embodiment is described in the book “Connect.” However, it is, again, noted that this is an illustrative embodiment and it is not intended that claimed subject matter necessarily be limited in scope to an illustration.

Taking advantage, again, in the game, of the symmetry of the cube structure, the nine categories of “Another Reality” may be arranged on face 600 as a mirror image of the arrangement of categories of “My Reality” on face 500, depicted for one embodiment as shown in FIG. 6. However, in another embodiment, instead, “Another Reality” may involve play with another person who may attempt their own arrangement on face 600 of the categories and/or subcategories just described, for example.

After an arrangement of categories on face 500 results from playing the game, continued play may involve determining an arrangement of subcategories within a particular category. As an example, as shown, one place for the category “Core” to be placed on face 500 is at large cell 515 in the center of face 500. This might follow from the association between the meaning of “Core” and the location in the center, for example. Likewise, as shown in FIG. 5, category “Core” may have the following nine subcategories, that, as explained in “Connect,” may relate to a person's Core values, for example: Heart, Conscious, Truth, Purpose, Choice, Genetics, Subconscious. Individuality (or Soul) and Survival. However, a person playing the game might chose to arrange those subcategories differently than the depiction of FIG. 5 and may, instead, reflect what might be at the “Core” of that person's “Reality.” Thus, as suggested, the game may be understood as unscrambling the appropriate location of topics, categories and/or subcategories that have been arranged on a cube, in this example, on cube face 500 with the topic “My Reality,” as an illustration. Likewise, a similar process may be applied to the other categories of “My Reality” to play the game and attempt to produce a complete unscrambled cube face with respect to the person playing the game.

As just indicated, one manner of play may be employed with respect to placement of the other categories on face 500 and, likewise, with respect to placement of other subcategories with respect to those categories. However, in addition, as the face becomes filled out, vertical, horizontal, and/or diagonal symmetries of the cube face may also become apparent. These symmetries are shown more clearly in FIG. 4, in which a horizontal symmetry may relate to a middle row of nine rows, perhaps thought of as an “x-axis,” through the horizontal centers of large cells 535, 515 and 540. In a similar manner, a vertical symmetry may relate to a middle column of nine columns, perhaps thought of as a “y-axis,” through the vertical centers of large cells 525, 515, and 550. Likewise, diagonal symmetries may comprise two crossing full length diagonals of face 500, at least one of which perhaps may be thought of as a “z-axis,” for example, through the top left to bottom right diagonals through large cells, 520, 515, and 555, in an embodiment, such as, again, described in the book “Connect.”

Continuing, for an embodiment of a game or puzzle, again referring to FIG. 5, a player may compare the nine subcategories in the top most row of face 500 (i.e., the top rows of large cells 520, 525, and 530 of FIG. 4) and consider whether the selected arrangement appropriately reflects how the player associates those subcategories with their respective positions in the row and considering, for example, how the positions relate to the positions of the categories of which the subcategories are a part. A similar manner of play may then be applied to the remaining horizontal rows of the cube face. However, likewise, a similar manner of play may be applied to the vertical columns of face 500 and to at least one major diagonal, such as previously described with respect to FIG. 4, for example, which respectively also contain nine subcategories.

A feature included in an embodiment of a game or puzzle is that selected patterns of selected topic labels, category labels and/or the subcategory labels on the cube-like faces of a cube are capable of being modified further so as to capture at least one particular relationship between the selected topic labels, category labels and/or subcategory labels that aligns with a spatial symmetry on one or more faces of a cube and/or among the one or more faces of a cube.

Although FIG. 6 shows face 600 as a mirror image of face 500, after a face is completed, such as face 500, instead, a similar manner of play may be employed with respect to face 600 and its topic. For example, as mentioned, in another embodiment, instead, “Another Reality” may involve play with another person who may attempt their own arrangement on face 600 of categories and/or subcategories.

An example of a similar manner of play may likewise be employed with respect to another face and its topic, which may, for example, involve face 700 with the topic “Knowledge.” FIG. 7 depicts an arrangement of categories and/or subcategories on face 700 for this topic. Face 700 has the same or a substantially similar physical structure as was described for face 500. A similar manner of play may then be employed with respect to the topic of “Knowledge” and face 700. For example, categories for topic “Knowledge” may include Science. Health, History, Math. Philosophy, Technology, Nature. Homo Sapiens, and the Unknown, in an example embodiment. Thus, categories may be arranged using physical labels in nine large cell positions on face 700 for positions of large cells on face 700 described as center, top, bottom, left, right, and corners, as previously discussed with respect to face 500. Likewise, the corners may be described as top left, top right, bottom left and bottom right. Then, within the nine large cells, subcategories may be similarly arranged for positions within the large cells described as center, top, bottom, left, right, and corners. Again, the corners may be described as top left, top right, bottom left and bottom right. Continuing with play, subcategories of face 700 may be compared along the horizontal and vertical rows of face 400 and along at least one of the two main diagonals, such as previously described, for example. An additional feature to note, as shown in FIG. 7, is that some small cells for subcategories are blank. Likewise, for FIGS. * and FIG. 10, some small cells for subcategories are blank. Thus, in an embodiment of a game or puzzle, blanks, such as blank physical labels, for example, may be provided so that players may employ labels of their own choosing.

A similar manner of play may then be conducted for the other cube faces and topics. For face 800, for example, shown in FIG. 8, which in this embodiment has the selected topic “Influence,” the nine category labels may comprise: Institutions, Environment, Nature, Interactions, Emotions, Senses, Influencers, Behavior, and Incentives & Deterrents. It is noted that for faces 700 and 800, instead of a single player, play may involve multiple players discussing how to arrange categories and/or subcategories for topics “Knowledge” and “Influence,” for example. Likewise, play may involve a parent and child so that the child may learn through discussion of how to arrange the categories and/or subcategories. Furthermore, as mentioned, in an embodiment of a game or puzzle, blanks, such as blank physical labels, for example, may be provided so that players may employ labels of their own choosing, illustrated, for example, by blanks in FIGS. 7 and 8.

For faces 900 and 100), which are approximate mirror image faces for the topics “Positive” and “Negative”, shown in FIGS. 9 and 10, categories in this embodiment may include: Checks & Balances, Institutions, Protocols, Consume, Core-Values. Environment, Beliefs, People Groups, and Wisdom (Positive side) or Foolishness (Negative side). That is, Wisdom is the opposite (e.g., mirror image) of Foolishness. In an embodiment, therefore, these faces may be played in a manner similar to previously described for the other faces. Furthermore, as previously suggested, for FIG. 10, some small cells for subcategories are blank. In addition, in some cases, in an embodiment, a physical label may comprise an expression (e.g., several words), rather than merely a word. Examples include: “Be a man of your word.” or “No money in politics.” as shown in FIG. 10, for example. Of course, claimed subject matter is not necessarily intended to be limited in scope in these respects.

In another or additional embodiment, colors may also be assigned to cube faces in connection with a puzzle or game embodiment. For a physical cube, in an embodiment, for example, topics may be fixed along with colors for selected cube faces. On the other hand, perhaps respective cube faces may include a color wheel or similar device so that the wheel may mix primary and/or secondary colors, for example, in order to make color selections for different cube faces.

As suggested regarding position, some significance may be associated with selected colors, as well as which colors are assigned to particular cube faces. How these colors may be arranged involves reasoning, analogies, experiences, etc. applied by the person playing the game or solving the puzzle through application of that person's understanding of the face topics while also attributing significance to particular relative face positions on the cube so that how the colors relate to one another also relates to the relative positions of the particular topics with respect to particular faces of the cube.

One illustrative embodiment is described in “Connect,” which illustrates how colors may be employed in a game or puzzle embodiment to figure out an arrangement, although claimed subject matter is not intended to necessarily be limited to that illustration. For example, for the six faces that are assigned topics, colors might be assigned as follows: blue for My Reality (face 500); red for Another Reality (face 600); orange for Knowledge (face 700); green for Influence (face 800); yellow for Positive (face 1000); and purple for Negative (face 900), with appropriate rationales provided, for example, as described in “Connect.”

In an example implementation, a physical Connection Cube embodiment may be constructed using six independent boards that may be physically combined to make a cube. The arrangements of physical labels of topics, categories and/or subcategories on a constructed Connection Cube embodiment may demonstrate and/or symbolize to a player, how “connected” we are as people within a society, as an example.

Any one of a number of suitable materials may be employed to fabricate the boards or even an entire cube as a single self-contained structure, for example. A host of options are available and are intended to be included within the scope of claimed subject matter. Examples of materials without intending to limit claimed subject matter include: any type of one or more polymers (include Styrofoam, as one example), which may also include compositions thereof; any type of wood product and/or wood-like materials (which may include cardboard as a wood product) or any compositions thereof; one or more types of metal, which may include compositions thereof, such as alloys; masonry materials, which may include stone, ceramic, or any compositions of masonry materials; concrete and/or concrete-like materials, or combinations thereof; glass and/or glass-like products or combinations thereof; any one of a number of available solid and/or solidifiable composites; or any combinations of any of the foregoing. Such materials may also in many cases be employed to create physical labels, although relatively lightweight materials are more desirable. Thus, again, for physical labels, a host of options are available and are intended to be included within the scope of claimed subject matter.

Likewise, a structure, such as a board or face of a cube structure, in an embodiment, may be covered (and/or colored) with magnetic paint, although any one of a number of cosmetically pleasing substances may be employed, including, again, without intending to limit the scope of claimed subject matter, thermoplastics and/or thermosets, resins, blends, colored composites, etc. In an embodiment, magnetic paint may facilitate the use of physical labels to be attached to a cube face and maintain a position as attached.

Of course, besides employing magnetic properties to attach physical labels, again, a host of options for accomplishing physical label attachment are available and are intended to be included within the scope of claimed subject matter. Examples, besides employing magnets on the back of a physical label, includes adhesives (likewise, an adhesive may attach a physical label to a magnet). Velcro material, suction devices, screw-like attachments to fit into threaded holes in a cube face, and/or other interlocking mechanisms, transparent plastic sleeves fixed or otherwise attached to a cube face, push pins, or any combinations of any of the foregoing. Essentially, any known technique for attaching a physical label may be employed in accordance with claimed subject matter.

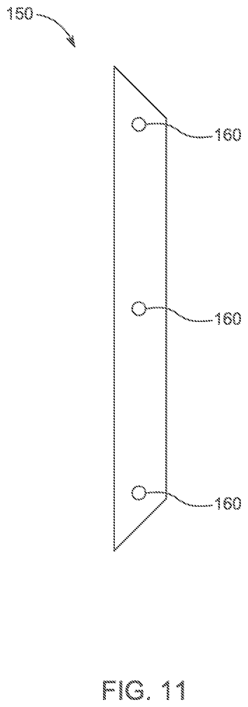

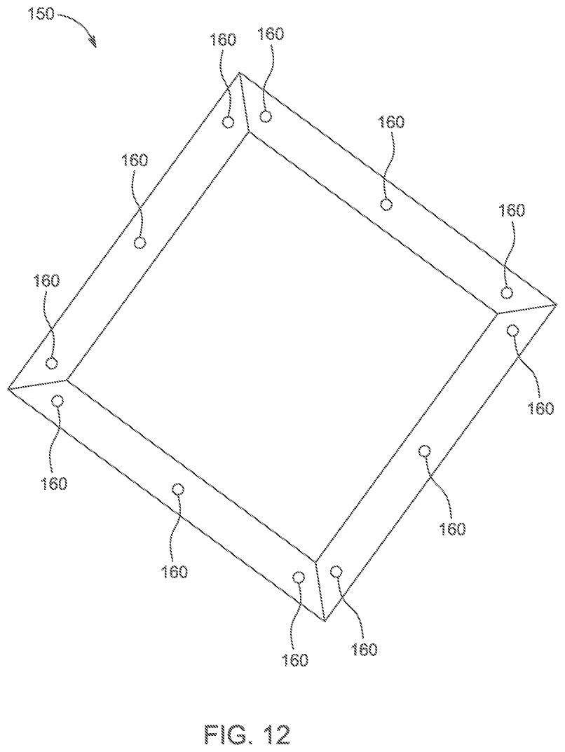

In an embodiment, as an illustration, plastic manufactured boards may be constructed to magnetically connect to form a cube. For example, a particular implementation may be around 14 or 15 inches tall and wide with the cell within a cell (e.g., macro and micro three by three) grid structure on the face of the board, as previously discussed and illustrated. Continuing with this size as an illustrative example of one scale, all four edges of a square flat board (e.g., for a cube face) of plastic may make a 45 degree angle with the plane of the board and may be roughly ⅞ of an inch in length to support two or three magnets, as an example, which are intended to be employed to physically connect all six faces or sides to form the cube or cube-like structure for an embodiment. FIGS. 11 and 12 illustrate schematic diagrams of a side view of an embodiment 150 with magnets 160 and top view of the embodiment 150 with magnets 160 of such a board implementation. Thus, six square flat boards may be arranged to form a cube, in an example implementation or embodiment, so that the 45 degree edges of the respective flat square boards come into direct physical contact and the magnets hold the boards in place to form the cube structure.

In another embodiment, rather than constructing a physical cube-like structure in order to arrange topics, categories and/or subcategories, a game or puzzle may be played on a computer or similar device, such as a computing system, executing software designed to enable play similar to the type of play with respect to a game or puzzle involving a physical cube-like structure, as previously described. However, instead, any structures or faces for such a game or puzzle as well as labels, for example, may be rendered as “virtual images.” such as on a display device (note that the display device itself may be considered physical)

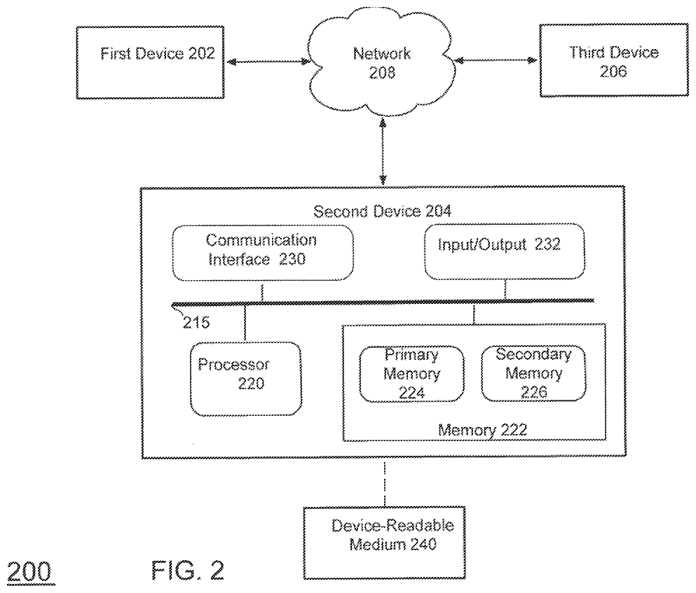

Referring now to FIG. 2, in an embodiment, first and third devices 202 and 206 may be capable of rendering a graphical user interface (GUI) for a network device and/or a computing device, for example, so that a user-operator may engage in system use. Device 204 may potentially serve a similar function in this illustration. Likewise, in FIG. 2, computing device 202 (‘first device’ in figure) may interface with computing device 204 (‘second device’ in figure), which may, for example, comprise features of a client computing device and/or a server computing device, in an embodiment. Processor (e.g., processing device) 220 and memory 222, which may comprise primary memory 224 and secondary memory 226, may communicate by way of a communication bus 215, for example. The term “computing device,” in the context of the present Patent Application, refers to a system and/or a device, such as a computing apparatus, that includes a capability to process (e.g., perform computations) and/or store digital content, such as electronic files, electronic documents, measurements, text, images, video, audio, etc. in the form of signals and/or states. It is further noted that the term “computing device.” in general, whether employed as a client and/or as a server, or otherwise, refers at least to a processor and a memory connected by a communication bus, such as illustrated in FIG. 2. Thus, a computing device, in the context of the present Patent Application, may comprise hardware, software, firmware, or any combinations thereof (other than software per se). Computing device 204, as depicted in FIG. 2, is merely one example, and claimed subject matter is not necessarily limited in scope to this particular example.

For one or more embodiments, a device, such as a computing device and/or networking device, may comprise, for example, any of a wide range of digital electronic devices. These may include, but are not limited to, desktop and/or laptop computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IoT) type devices, or any combinations of the foregoing. These may also include, but are not otherwise limited to, current and/or next generation stand-alone virtual reality (VR), augmented reality (AR), mixed reality (MR), and/or “xtended” reality (XR) devices, or any combinations of the foregoing. Likewise, the terms computing device, computer, computer device, computer system, computer platform and the like may be used interchangeably without loss of generality or understanding. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a web-enabled computing device may include a physical and/or a virtual keyboard, mass storage, one or more accelerometers, one or more gyroscopes, global positioning system (GPS) and/or other location-identifying type capability, and/or a display with a high degree of functionality, such as a touch-sensitive color 2D or 3D display.

Communications between a computing device and/or a network device, such as 202 and/or 204, and a wireless network, as an example, may be in accordance with known and/or to be developed network protocols including, but not limited to, for example, global system for mobile communications (GSM), enhanced data rate for GSM evolution (EDGE), 802.11b/g/n/h, etc., worldwide interoperability for microwave access (WiMAX), 3G, 4G, 50, as well as any or all next generation wireless network protocols, or any combinations thereof. A computing device and/or a networking device may also have a subscriber identity module (SIM) card, which, for example, may comprise a detachable or embedded smart card that is able to store subscription content of a user, and/or is also able to store a contact list. It is noted, however, that a SIM card may also be electronic, meaning that it may simply be stored in a particular location in memory of the computing and/or networking device. A user may own the computing device and/or network device or may otherwise be a user, such as a primary user, for example. A device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a computing and/or communications network may be embodied as a wired network, wireless network, or any combinations thereof.

A computing and/or network device may include and/or may execute a variety of now known and/or to be developed operating systems, derivatives and/or versions thereof, including computer operating systems, such as Windows, iOS, Linux, a mobile operating system, such as iOS. Android, Windows Mobile, and/or the like. A computing device and/or network device may include and/or may execute a variety of possible applications, such as a client software application enabling communication with other devices. For example, one or more messages (e.g., content) may be communicated, such as via one or more protocols, now known and/or later to be developed, suitable for communication of email, short message service (SMS), and/or multimedia message service (MMS), including via a network, such as a social network, formed at least in part by a portion of a computing and/or communications network, including, but not limited to, Facebook, LinkedIn, Twitter, and/or Flickr, to provide only a few examples. A computing and/or network device may also include executable computer instructions to process and/or communicate digital content, such as, for example, textual content, digital multimedia content, and/or the like. A computing and/or network device may also include executable computer instructions to perform a variety of possible tasks, such as browsing, searching, playing various forms of digital content, including locally stored and/or streamed video, and/or games such as, but not limited to, fantasy sports leagues. The foregoing is provided merely to illustrate that claimed subject matter is intended to include a wide range of possible features and/or capabilities.

Thus, in an embodiment, an article may comprise: a non-transitory storage medium, where the storage medium may include stored thereon executable instructions, where the instructions may be executable by a computing device, for example, to computer generate six uncombined virtual cube faces that if combined could and/or would form a virtual cube, and where the instructions may be executable to implement a word game that comprises arranging selected virtual category labels from a group of virtual category labels and/or arranging selected virtual subcategory labels from a group of virtual subcategory labels so as to take selected positions on the six virtual faces in which a respective virtual face may Correspond with a respective selected topic of multiple topics to form a particular arrangement related to a symmetrical structure between the virtual faces so as to contrast the selected topics in a manner that at least relates to the symmetrical structure of the virtual cube that would and/or could be formed from combining the uncombined cube faces.

In such an illustrative embodiment, instructions may be further executable to computer generate one respective face of the six faces that may have a structure of a number of large cells such that the number of large cells are able to be arranged in a square structure on the one respective face, in which the large cells of the one respective face respectively may have a space for placement of a virtual category label in which the category may comprise a category within the respective selected topic of the one respective face. Furthermore, the number of different virtual labels for the number of different categories within the respective selected topic of the respective one face may correspond to the number of large cells such that the categories are able to be arranged in the square structure so as to contrast the different selected categories of the respective selected topic of the one respective face in a manner that at least may relate to the symmetry of the large cell square structure of the one respective face. Illustrative examples are shown, for example, in FIGS. 4 and 5. Thus, in an embodiment, nine large cells may be arranged on a face in a symmetrical fashion, as illustrated, for example, in FIGS. 4 and 5.

Continuing, in such an illustrative embodiment, instructions may be further executable to computer generate one respective large cell of the number of large cells that may be intended to have a selected virtual category label in which the selected category may comprise a category within the respective selected topic of the one respective face, the one respective large cell intended to have a number of small cells arranged in a square structure within the one respective large cell, in which the small cells of the one respective large cell respectively may have a space for placement of a virtual subcategory label in which the subcategory may comprise a subcategory within the selected category of the one respective large cell. Furthermore, in such an embodiment, the different virtual labels for the different subcategories within the respective selected category may correspond to the number of small cells in the one respective large cell such that the small cells are to be arranged in the square structure so as to contrast the different selected subcategories within the selected category in a manner that at least relates to the symmetry of the small cell square structure of the one respective large cell. Thus, in an embodiment, nine small cells may be arranged within a large cell in a symmetrical fashion, as illustrated, for example, in FIGS. 4 and 5. It is noted that such an embodiment may, but need not necessarily, computer generate a three dimensional gaming environment, discussed in more detail below.

Likewise, however, in another or additional embodiment, the instructions may be further executable to computer generate a three-dimensional gaming environment, as described in more detail below, that includes a three-dimensional virtual cube structure in which the six uncombined virtual cube faces may be combined to form a three-dimensional virtual cube structure, for example.

In this context, the term “three-dimensional (3)) gaming environment” refers to a computer-generated three-dimensional virtual representation of a real-world environment, which may, as an example, be generated from geometric signal and/or state information, with the ability for a user to virtually move within and/or virtually interact with that three-dimensional virtual representation of a real-world environment. Furthermore, a 3D gaming environment, in an embodiment, may be fully immersive and/or photorealistic. As noted, an embodiment may or may not include software to computer generate a three dimensional gaming environment; however, an embodiment capable of generating a three dimensional gaming environment may include software capable of computer generating an implementation of a word game or puzzle that, for an embodiment, as an example, comprises arranging selected virtual category labels from a group of virtual category labels and/or arranging selected virtual subcategory labels from a group of virtual subcategory labels so as to take selected positions on the six virtual faces in which a respective virtual face may correspond with a respective selected topic in a particular arrangement of topics, for example, related to a symmetrical structure between the virtual faces so as to contrast the selected topics in a manner that at least relates to the symmetrical structure between the virtual faces if combined to form the virtual cube, such as previously described, for example.

Likewise, in an embodiment, instructions may be further executable to computer generate one respective face of the six virtual faces such that the virtual face may have a structure of a number of large cells in which the number of large cells are able to be arranged in a square structure on the one respective face. Likewise, in an embodiment, the large cells of the one respective face respectively may have a space for placement of a virtual category label in which the category may comprise a category within the respective selected topic of the one respective face. Furthermore, the number of different virtual labels for the number of different categories within the respective selected topic of the respective one face may correspond to the number of large cells such that the categories are able to be arranged in the square structure so as to contrast the different selected categories of the respective selected topic of the one respective face in a manner that at least may relate to the symmetry of the large cell square structure of the one respective face. Illustrative examples are shown, for example, in FIGS. 4 and 5. Thus, in an embodiment, nine large cells may be arranged on a face in a symmetrical fashion, as illustrated, for example, in FIGS. 4 and 5.

Continuing, in such an illustrative embodiment, instructions may be further executable to computer generate one respective large cell of the number of large cells that may be intended to have a selected virtual category label in which the selected category may comprise a category within the respective selected topic of the one respective face, the one respective large cell intended to have a number of small cells arranged in a square structure within the one respective large cell, in which the small cells of the one respective large cell respectively may have a space for placement of a virtual subcategory label in which the subcategory may comprise a subcategory within the selected category of the one respective large cell. Furthermore, in such an embodiment, the different virtual labels for the different subcategories within the respective selected category may correspond to the number of small cells in the one respective large cell such that the small cells are to be arranged in the square structure so as to contrast the different selected subcategories within the selected category in a manner that at least relates to the symmetry of the small cell square structure of the one respective large cell. Thus, in an embodiment, nine small cells may be arranged within a large cell in a symmetrical fashion, as illustrated, for example, in FIGS. 4 and 5.

Additional details regarding the components of computing device 204 are described later. However, it is noted that, in an embodiment, computing device 204 may comprise a computing device or system that includes a state-of-the art graphics processor unit (GPU) and a state-of-the-art central processing unit (CPU), such as the Nvidia RTX3070 GPU, available from Nvidia Corp., and the Intel Core i9 microprocessor, available from Intel Corp., both located in San Jose, CA, as merely examples. It is noted, of course, that claimed subject matter is not limited in scope in this respect. Nonetheless, such an embodiment, for example, may include software capable of computer generating a cube face having the cell within a cell structure, as previously described with respect to a cube face of a physical cube, for use in playing a word game or puzzle as previously described. For example, in this context, software may computer generate a three-dimensional virtual representation of a real-world environment, which may, as an example, be generated from geometric signal and/or state information, with the ability for a user to virtually move within and/or virtually interact with that three-dimensional virtual representation of a real-world environment. Furthermore, a 3D gaming environment, in an embodiment, may be fully immersive and/or photorealistic. As an example, an embodiment may computer generate a three-dimensional gaming environment, as described previously, that includes a three-dimensional virtual cube structure in which the six uncombined virtual cube faces may be combined to form a three-dimensional virtual cube structure, for example.

Likewise, in an embodiment, instructions may be further executable to computer generate one respective face of the six virtual faces such that the virtual face may have a structure of a number of large cells in which the number of large cells are able to be arranged in a square structure on the one respective face. Likewise, in an embodiment, the large cells of the one respective face respectively may have a space for placement of a virtual category label in which the category may comprise a category within the respective selected topic of the one respective face. Furthermore, the number of different virtual labels for the number of different categories within the respective selected topic of the respective one face may correspond to the number of large cells such that the categories are able to be arranged in the square structure so as to contrast the different selected categories of the respective selected topic of the one respective face in a manner that at least may relate to the symmetry of the large cell square structure of the one respective face. Illustrative examples are shown, for example, in FIGS. 4 and 5. Thus, in an embodiment, nine large cells may be arranged on a face in a symmetrical fashion, as illustrated, for example, in FIGS. 4 and 5.

Continuing, in such an illustrative embodiment, instructions may be further executable to computer generate one respective large cell of the number of large cells that may be intended to have a selected virtual category label in which the selected category may comprise a category within the respective selected topic of the one respective face, the one respective large cell intended to have a number of small cells arranged in a square structure within the one respective large cell, in which the small cells of the one respective large cell respectively may have a space for placement of a virtual subcategory label in which the subcategory may comprise a subcategory within the selected category of the one respective large cell. Furthermore, in such an embodiment, the different virtual labels for the different subcategories within the respective selected category may correspond to the number of small cells in the one respective large cell such that the small cells are to be arranged in the square structure so as to contrast the different selected subcategories within the selected category in a manner that at least relates to the symmetry of the small cell square structure of the one respective large cell. Thus, in an embodiment, nine small cells may be arranged within a large cell in a symmetrical fashion, as illustrated, for example, in FIGS. 4 and 5. It is noted that such an embodiment may, but need not necessarily, computer generate a three dimensional gaming environment, as previously discussed.

As another example of an embodiment, computing device 204 may comprise a server or even several servers, such as may be provided by Amazon Web Services (AWS), see https://aws.amazon.com/, or by Microsoft Azure, see https://azure.microsoft.com/en-us/get-started/azure-portal. For example, such one or more servers may include software executable to provide a “virtual machine,” denoted VM, so that it is not necessary to own a computing device or system to have the capability to computer generate a word game or puzzle such as in accordance with claimed subject matter, for example. For such an embodiment, computing device 204, for example, may be accessible via a network, such as via the Internet or the Worldwide Web. Again, claimed subject matter is not intended to be limited in scope to this illustrative example.

Nonetheless, in an embodiment, a computing device 204 may execute rendering software and/or other similar software tools to computer generate, for an embodiment, an implementation of a word game or puzzle in accordance with claimed subject matter. Likewise, in an embodiment, software may further have a capability to render a three-dimensional gaming environment. A host of commercial application software is available in this regard. As simply one example, Unreal Engine software, available from Epic Games, see https://en.wikipedia.org/wiki/Unreal_Engine, may be employed to computer generate a three-dimensional gaming environment. Furthermore, if employing a virtual machine, as described above, for an embodiment, AWS, see https://aws.amazon.com/about-aws/whats-new/2022/03/aws-gamekit-unreal-engine/and Azure, see https://learn.microsoft.com/en-us/gaming/azure/game-dev-virtual-machine/create-game-development-vn-for-unreal, both support Unreal Engine.

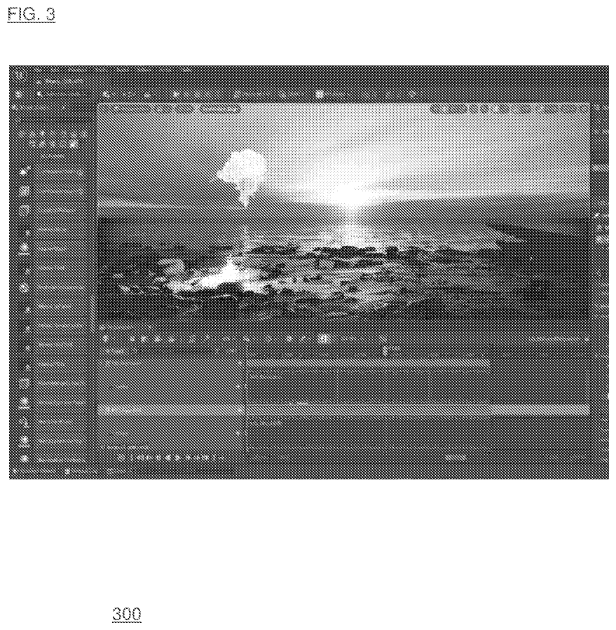

Unreal Engine (UE) is a three-dimensional (3D) computer graphics game engine developed by Epic Games, first showcased in the 1998 first-person shooter game Unreal. Initially developed for PC first-person shooters, it has since been used in a variety of genres of games and has also seen adoption by other industries, most notably the film and television industry. Written in C++, the Unreal Engine features a high degree of portability, supporting a wide range of desktop, mobile, console and/or virtual reality platforms. The latest generation, Unreal Engine 5, was launched in April 2022. Its source code is available on GitHub after registering an account, and commercial use is granted based on a royalty model. It is noted that there are several versions of Unreal Engine. For example, versions 4 and above, including versions that may later be developed, are included as illustrative examples. Referring to FIG. 3, as one example, Unreal Engine 5.1 is illustrated by a screen shot 300, as shown. Of course. Unreal Engine is simply one example, and it is not intended that claimed subject matter be limited in scope to Unreal Engine software.

Unreal Engine 5 was revealed on May 13, 2020 by Epic Games. It was released in early access on May 26, 2021, and formally launched for developers on Apr. 5, 2022. One of its major features is Nanite, an engine that allows for detailed photographic source material to be imported into games.

The goal of Unreal Engine 5 was to make it as easy as possible for game developers to create detailed game worlds without having to spend excessive time on creating new detailed assets. Among its features are collision detection, colored lighting, and texture filtering. An integrated level editor, UnrealEd, that has support for real-time constructive solid geometry operations, allows mappers to change the level layout on the fly.

Nanite can import nearly any other pre-existing three-dimensional representation of objects and environments, enabling the use of film-quality assets. Nanite automatically handles the levels of detail (LODs) of these imported objects appropriate to the target platform and draw distance, a task that an artist would have had to perform otherwise. Lumen is another component described as a “fully dynamic global illumination solution that immediately reacts to scene and light changes”. Lumen eliminates the need for artists and/or developers to craft a lightmap for a given scene, but instead calculates light reflections and shadows on the fly, thus allowing for real-time behavior of light sources. Virtual Shadow Maps is another component added in Unreal Engine 5 described as “a new shadow mapping method used to deliver consistent, high-resolution shadowing that works with film-quality assets and large, dynamically lit open worlds”. Virtual Shadow Maps differs from the common shadow map implementation in its extremely high resolution, more detailed shadows, and the lack of shadows popping in and out which can be found in the more common shadow map technique due to shadow cascades. Additional components include Niagara for fluid and particle dynamics and Chaos for a physics engine. With potentially tens of billions of polygons present on a single screen at 4K resolution, Epic also developed the Unreal Engine 5 to take advantage of the upcoming high-speed storage solutions with next-generation console hardware expected to use a mix of RAM and custom solid-state drives.

A version of Unreal Engine, Unreal Engine 5.1, is currently available. Thus, executing on a computing device, such as 204, which may, as described, comprise a platform with one or more state of the art GPUs and CPUs, or which may comprise a virtual machine (VM), executing on one or more servers, such as via AWS or Microsoft Azure, an immersive, photorealistic, virtual three-dimensional gaming environment is able to be computer generated, in an embodiment. Other examples of computer-generated virtual 3D gaming environments are provided in U.S. Pat. No. 8,384,710, titled “Displaying and Using 3D graphics On Multiple Displays Provided for Gaming Environments,” issued to Schlottmann, et. al., on Feb. 26, 2013: U.S. Pat. No. 10,846,937, titled “Three-Dimensional Virtual Environment.” issued to Rogers et. al., on Nov. 24, 2020; and U.S. Pat. No. 11,471,775, titled “System and Method for Providing a Computer-Generated Environment.” issued to Benzies, on Oct. 18, 2022.

Likewise, a host of three-dimensional models are available or may be created that are able to be rendered on a computing device, such 204. Unreal Engine 5.1 is an example of software to computer generate a 3D model. Thus, for example, a 3D model for a virtual cube-like structure may be generated. Of course, claimed subject matter is not intended to be limited to any particular 3D model or even to necessarily computer generating a three dimensional gaming environment. For example, as described, an embodiment may include rendering software and/or other similar software tools to computer generate an implementation of a word game or puzzle such as previously described, for example, un an embodiment. In one such embodiment, for example, a user may be able to virtually navigate between and/or among cube faces, large cells of a cube face, and/or small cells of a large cell. For one embodiment, navigation might be accomplished with a mouse, for example, in which moving the mouse may result in movement on a display screen, for example. Likewise, a mouse, again, merely as an example, may permit zooming in and/or zooming out, perhaps via scrolling, for example. Again, these are merely illustrative examples.

Likewise, in another embodiment that may render a 3D gaming environment, once or after a 3D model is edited and complete, for a computing device, such as 204, it may be rendered by executing Unreal Engine 5.1, for example. Once or after being rendered, a user, sometimes described as a first person in a game, as suggested above, in a “play” virtual navigation mode, may be able to virtually navigate within the 3D gaming environment to move among and/or between different virtual cube faces so as to place virtual labels in particular cell locations, mimicking, in an embodiment, the approach previously described with respect to a physical cube or cube-like structure with physical labels. In this illustrative embodiment, of course, the cube and the labels are virtual rather than physical, as suggested previously. Again, in one particular virtual navigation mode, for example, this may be done via a mouse and/or similar input device. Likewise, in a “play” virtual navigation mode, it may be possible for multiple individuals to “play” at the same time, which may even be done using networking technology, such as previously described, as an example, via a “virtual machine.” from AWS or Azure, as examples, so individuals may “play” from separate physical locations.

For the purposes of this patent application, in an embodiment, a game as described involving a virtual cube-like structure and virtual labels to be placed in positions on the cube, such as previously described for topics, categories and/or subcategories, may be executed using any device or set of devices able to render and, therefore, display a three-dimensional gaming environment. Thus, typically, a computing device and/or computing system, with a suitable manner of displaying visual content in three dimensions, comprises an example. However, it may include many other devices, as well, including, as examples, but without limitation, tablets, smart phones, labtops, high resolution 2D computer displays, mobile smartphones, HDTV, video projectors, current and/or next generation virtual reality (VR), augmented reality (AR), mixed reality (MR), and/or “xtended” reality (XR) googles and/or glasses, or any combinations of the foregoing. For example, in many instances, a display device, such as a high resolution 2D computer display or virtual reality glasses or goggles, may be able to connect or couple to a computing device, for example, such as via a wired or wireless connection.

Continuing with discussion of an example embodiment, a 3D cube structure for use in play may be created via execution by Unreal Engine of a “blueprint script.” The blueprint visual scripting system, for example, in Unreal Engine is a complete gameplay scripting system based on the concept of using a node-based interface to create gameplay elements from within the Unreal Editor. See, for example, “Introduction to Blueprints,” https://docs.unrealengine.com/4.27/en-US/ProgrammingAndScripting/Blueprints/GettingStarted/#:˜:text=The %20Blueprint %20Visual %20Scripting %20systemn,or %20objects %20in %20the %20engine. The blueprint visual scripts translate to executable C++ code. Likewise, Unreal Engine, executes the blueprints written for the blueprint visual scripting system, which executes the associated C++ code, in this example. See WebBrowser 1 Unreal Engine Documentation, https://docs.unrealengine.com/5.0/en-US/API/Runtime/WebBrowser/. See also Customizing the Player Web Page Unreal Engine4.27Documentation,https://docs.unrealengine.com/4.27/enUS/SharingAndReleasing/Pixel Streaming/CustomPlayer/. However, again, as mentioned, claimed subject matter is not limited in scope to employing Unreal Engine. Rather, it is provided as an illustrative example.

In terms of a 3D gaming environment, a user may be viewed as a player, often termed a “first person.” This refers to the user who would then be navigating between and/or among the faces of a virtual 3D cube or virtual cube-like structure and also be interacting with the 3D virtual display(s) to affect the content shown or displayed, such as by placement of virtual labels, in a manner as illustrated and discussed above, as one example. Consequently, within a 3D gaming environment, in order to generate a game for play by users, 3D virtual content may be arranged in a particular configuration and selected 3D virtual content may be populated so as to form a “template” for the display of and/or interaction with a virtual cube-like structure to be used in playing a game or solving a puzzle by placement of virtual labels on a virtual cube or cube-like structure in a manner similar to the approach previously described and also illustrated above for a physical cube or cube-like structure with physical labels for the placement of topics, categories and/or subcategories, in an embodiment. It is noted, for an embodiment using Unreal Engine, as an example, a “blueprint script” of the blueprint visual scripting system, for example, may be employed to form such templates, perhaps with a particular 3D model, depending on the particular template.

Previously, a mouse-driven approach to navigating for an embodiment of a game or puzzle was mentioned. However, claimed subject matter is not limited in scope to those examples. Other modes and/or ways to navigate are intended to be included within the scope of claimed subject matter. It is noted for an embodiment using Unreal Engine, as an example, using a “blueprint script” of the blueprint visual scripting system, for example, various navigation modes may be implemented. Likewise, in an embodiment either with or without a 3D gaming environment, navigation for a game or a puzzle in accordance with claimed subject matter may be accomplished via at least one of: mouse clicks, keyboard touch events, screen touch events, remote control actuation events, speaking events, or any combinations thereof.

Likewise, in another or additional embodiment, the instructions may be further executable so that colors may also be assigned to virtual cube faces in connection with a puzzle or game implemented via a computer or computing device. In an embodiment, for example, different colors of a selection, which might in an embodiment, permit mixtures thereof, may be chosen for six virtual cube faces.

As suggested regarding position, in an embodiment, some significance may be associated with selected colors, as well as which colors may be assigned to which uncombined cube faces based at least in part on relative cube face symmetries if the uncombined cube faces were combined to form a virtual cube, whether necessarily displayed or not in an embodiment. How these colors may be arranged involves reasoning, analogies, experiences, etc. applied by the person playing the game or solving the puzzle through application of that person's understanding of the face topics while also attributing significance to particular relative cube faces as would be positioned on a cube formed by combining the uncombined faces so that how the colors relate to one another also may relate to the relative cube faces of the particular topics as situated with respect to other cube faces if such cube faces were combined to form a cube.

One illustrative embodiment is described in “Connect.” which illustrates how colors may be employed in a game or puzzle embodiment to figure out an arrangement of colors for the cube faces, although claimed subject matter is not intended to necessarily be limited to that illustration. For example, in one embodiment, for the six faces that were previously assigned topics, colors might, for example, be assigned as follows: blue for My Reality (face 500); red for Another Reality (face 600); orange for Knowledge (face 700); green for Influence (face 800); yellow for Positive (face 1000); and purple for Negative (face 900).

In the context of the present Patent Application, the term “connection.” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus. “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present Patent Application, since memory, such as a memory component and/or memory states, is intended to be non-transitory, the term physical, at least if used in relation to memory necessarily implies that such memory components and/or memory states, continuing with the example, are tangible.

Additionally, in the present Patent Application, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance, between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath.” in such a particular context of usage, is intended to necessarily imply physical and tangible contact (similar to “on.” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up.” “down,” “top.” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present Patent Application, the term “or” if used to associate a list, such as A, B, or C, is intended to mean A, B, and C, here used in the inclusive sense, as well as A, B. or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular and/or the plural, “and/or” is also used to describe a plurality and/or some other combination of features, structures, characteristics, and/or the like. Likewise, the terms “based”, “based on” and/or similar terms are understood as not necessarily intending to convey an exhaustive list of factors, but to allow for existence of additional factors not necessarily expressly described.

To the extent claimed subject matter is related to one or more particular measurements, such as with regard to physical manifestations capable of being measured physically, such as, without limit, temperature, pressure, voltage, current, electromagnetic radiation, etc., it is believed that claimed subject matter does not fall within the abstract idea judicial exception to statutory subject matter and/or patent eligibility. Rather, it is asserted, that physical measurements are not mental steps and, likewise, are not abstract ideas. Thus, it is understood, of course, that a distribution of scalar numerical values, for example, without loss of generality, substantially in accordance with the foregoing description and/or later description, is related to physical measurements, and is likewise understood to exist as physical signals and/or physical signal samples.

The terms “correspond”, “reference”, “associate”, and/or similar terms relate to signals, signal samples and/or states, e.g., components of a signal measurement vector, which may be stored in memory and/or employed with operations to generate results, depending, at least in part, on the above-mentioned, signal samples and/or signal sample states. For example, a signal sample measurement vector may be stored in a memory location and further referenced wherein such a reference may be embodied and/or described as a stored relationship. A stored relationship may be employed by associating (e.g., relating) one or more memory addresses to one or more other memory addresses, for example, and may facilitate an operation, involving, at least in part, a combination of signal samples and/or states stored in memory, such as for processing by a processor and/or similar device, for example. Thus, in a particular context, “associating,” “referencing,” and/or “corresponding” may, for example, refer to an executable process of accessing memory contents of two or more memory locations, e.g., to facilitate execution of one or more operations among signal samples and/or states, wherein one or more results of the one or more operations may likewise be employed for additional processing, such as in other operations, or may be stored in the same or other memory locations, as may, for example, be directed by executable instructions. Furthermore, terms “fetching” and “reading” or “storing” and “writing” are to be understood as interchangeable terms for the respective operations, e.g., a result may be fetched (or read) from a memory location; likewise, a result may be stored in (or written to) a memory location.

It is further noted that the terms “type” and/or “like.” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be substantially present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present Patent Application merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices and/or one or more server devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device and/or a client device, as well as other types of devices, including between wired and/or wireless devices coupled via a wired and/or wireless network, for example.

In the context of the present Patent Application, the term network device refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combinations thereof. As mentioned, signal packets and/or frames, for example, may be exchanged, such as between a server device and/or a client device, as well as other types of devices, including between wired and/or wireless devices coupled via a wired and/or wireless network, for example, or any combinations thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device 1 also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combinations thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present Patent Application, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present Patent Application, the term “transparent,” if used with respect to devices of a network, refers to devices communicating via the network in which the devices are able to communicate via one or more intermediate devices, such as one or more intermediate nodes, but without the communicating devices necessarily specifying the one or more intermediate nodes and/or the one or more intermediate devices of the one or more intermediate nodes and/or, thus, may include within the network the devices communicating via the one or more intermediate nodes and/or the one or more intermediate devices of the one or more intermediate nodes, but may engage in signal communications as if such intermediate nodes and/or intermediate devices are not necessarily involved. For example, a router may provide a link and/or connection between otherwise separate and/or independent LANs.

In the context of the present Patent Application, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present patent application that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul public networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol. HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a public, self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present Patent Application, may comprise a service that organizes stored digital content, such as, for example, text, images, video, etc., through the use of hypermedia, for example. It is noted that a network, such as the Internet and/or Web, may be employed to store electronic files and/or electronic documents.

The terms electronic file and/or the term electronic document are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page. Web site, etc., in an embodiment. Of course. HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present Patent Application, the term “Web site” and/or similar terms refer to Web pages that are associated electronically to form a particular collection thereof. Also, in the context of the present Patent Application, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

In the context of the present Patent Application, the terms “entry,” “electronic entry,” “document,” “electronic document,” “content,” “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present Patent Application, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present Patent Application, the terms attributes (e.g., one or more attributes) and/or parameters (e.g., one or more parameters) refer to material descriptive of a collection of signal samples, such as one or more electronic documents and/or electronic files, and exist in the form of physical signals and/or physical states, such as memory states. For example, one or more parameters and/or attributes, such as referring to an electronic document and/or an electronic file comprising an image, may include, as examples, time of day at which an image was captured, latitude and longitude of an image capture device, such as a camera, for example, etc. In another example, one or more parameters and/or attributes relevant to digital content, such as digital content comprising a technical article, as an example, may include one or more authors, for example. Claimed subject matter is intended to embrace meaningful, descriptive attributes and/or parameters in any format, so long as the one or more parameters and/or attributes comprise physical signals and/or states, which may include, as examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”, may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this patent application, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present Patent Application, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present patent application, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular patent application, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present Patent Application, the term “between” and/or similar terms are understood to include “among” if appropriate for the particular usage and vice-versa. Likewise, in the context of the present Patent Application, the terms “compatible with.” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network, stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such as via participating digital devices and may be substantially compliant and/or substantially compatible with, but is not limited to, now known and/or to be developed, versions of any of the following network protocol stacks: ARCNET. AppleTalk, ATM. Bluetooth, DECnet, Ethernet, FDDI, Frame Relay, HIPPI, IEEE 1394, IEEE 802.11. IEEE-488, Internet Protocol Suite. IPX, Myrinet, OSI Protocol Suite, QsNet, RS-232, SPX, System Network Architecture. Token Ring, USB, PCI and/or X.25. A network and/or sub-network may employ, for example, a version, now known and/or later to be developed, of the following: TCP/IP. UDP, DECnet, NetBEUI. IPX, AppleTalk and/or the like. Versions of the Internet Protocol (IP) may include IPv4. IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, 4^{th} and/or 5th generation (2G, 3G, 4G, and/or 5G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), 802.11 b/g/n, and/or the like. A wireless network may include virtually any type of now known and/or to be developed wireless communication mechanism and/or wireless communications protocol by which signals may be communicated between devices, between networks, within a network, and/or the like, including the foregoing, of course.

In one example embodiment, as shown in FIG. 2, a system embodiment may comprise a local network (e.g., device 204 and medium 240) and/or another type of network, such as a computing and/or communications network. For purposes of illustration, therefore, FIG. 2 shows an embodiment 200 of a system that may be employed to implement either type or both types of networks. Network 208 may comprise one or more network connections, links, processes, services, applications, and/or resources to facilitate and/or support communications, such as an exchange of communication signals, for example, between a computing device, such as 202, and another computing device, such as 206, which may, for example, comprise one or more client computing devices and/or one or more server computing device. By way of example, but not limitation, network 208 may comprise wireless and/or wired communication links, telephone and/or telecommunications systems, Wi-Fi networks, Wi-MAX networks, the Internet, a local area network (LAN), a wide area network (WAN), or any combinations thereof.

Example devices in FIG. 2 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor,” for example, is understood to connote a specific structure such as a central processing unit (CPU) of a computing device which may include a control unit and an execution unit. In an aspect, a processor may comprise a device that interprets and executes instructions to process input signals to provide output signals. As such, in the context of the present Patent Application at least, computing device and/or processor are understood to refer to sufficient structure within the meaning of 35 USC § 112(f) so that it is specifically intended that 35 USC § 112(f) not be implicated by use of the term “computing device,” “processor” and/or similar terms; however, if it is determined, for some reason not immediately apparent, that the foregoing understanding cannot stand and that 35 USC § 112(f), therefore, necessarily is implicated by the use of the term “computing device,” “processor” and/or any other terms, then, it is intended, pursuant to that statutory section, that corresponding structure, material and/or acts for performing one or more functions be understood and be interpreted to be described at least in FIG. 2 and in the text associated with that figure of the present Patent Application.

In FIG. 2, computing device 202 may provide one or more sources of executable computer instructions in the form physical states and/or signals (e.g., stored in memory states), for example. Computing device 202 may communicate with computing device 204 by way of a network connection, such as via network 208, for example. As previously mentioned, a connection, while physical, may not necessarily be tangible. Although computing device 204 of FIG. 2 shows various tangible, physical components, claimed subject matter is not limited to a computing device having only these tangible components as other implementations and/or embodiments may include alternative arrangements that may comprise additional tangible components or fewer tangible components, for example, that function differently while achieving similar results. Rather, examples are provided merely as illustrations. It is not intended that claimed subject matter be limited in scope to illustrative examples.

Memory 222 may comprise any non-transitory storage mechanism. Memory 222 may comprise, for example, primary memory 224 and secondary memory 226, additional memory circuits, mechanisms, or combinations thereof may be used. Memory 222 may comprise, for example, random access memory, read only memory, etc., such as in the form of one or more storage devices and/or systems, such as, for example, a disk drive including an optical disc drive, a tape drive, a solid-state memory drive, etc., just to name a few examples.

Memory 222 may be utilized to store a program of executable computer instructions. For example, processor 220 may fetch executable instructions from memory and proceed to execute the fetched instructions. Memory 222 may also comprise a memory controller for accessing device readable-medium 240 that may carry and/or make accessible digital content, which may include code, and/or instructions, for example, executable by processor 220 and/or some other device, such as a controller, as one example, capable of executing computer instructions, for example. Under direction of processor 220, a non-transitory memory, such as memory cells storing physical states (e.g., memory states), comprising, for example, a program of executable computer instructions, may be executed by processor 220 and able to generate signals to be communicated via a network, for example, as previously described. Generated signals may also be stored in memory, also previously suggested.

Memory 222 may store electronic files and/or electronic documents, such as relating to one or more users, and may also comprise a computer-readable medium that may carry and/or make accessible content, including code and/or instructions, for example, executable by processor 220 and/or some other device, such as a controller, as one example, capable of executing computer instructions, for example. As previously mentioned, the term electronic file and/or the term electronic document are used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

Algorithmic descriptions and/or symbolic representations are examples of techniques used by those of ordinary skill in the signal processing and/or related arts to convey the substance of their work to others skilled in the art. An algorithm is, in the context of the present patent application, and generally, is considered to be a self-consistent sequence of operations and/or similar signal processing leading to a desired result. In the context of the present patent application, operations and/or processing involve physical manipulation of physical quantities. Typically, although not necessarily, such quantities may take the form of electrical and/or magnetic signals and/or states capable of being stored, transferred, combined, compared, processed and/or otherwise manipulated, for example, as electronic signals and/or states making up components of various forms of digital content, such as signal measurements, text, images, video, audio, etc.

It has proven convenient at times, principally for reasons of common usage, to refer to such physical signals and/or physical states as bits, values, elements, attributes, parameters, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining.” “establishing,” “obtaining,” “identifying,” “selecting,” “generating,” and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation. Likewise, a physical change may comprise a transformation in molecular structure, such as from crystalline form to amorphous form or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state from a binary one to a binary zero or vice-versa in a memory device may comprise a transformation, such as a physical, but non-transitory, transformation. Rather, the foregoing is intended as illustrative examples.

Referring again to FIG. 2, processor 220 may comprise one or more circuits, such as digital circuits, to perform at least a portion of a computing procedure and/or process. By way of example, but not limitation, processor 220 may comprise one or more processors, such as controllers, microprocessors, microcontrollers, application specific integrated circuits, digital signal processors, programmable logic devices, field programmable gate arrays, the like, or any combinations thereof. In various implementations and/or embodiments, processor 220 may perform signal processing, typically substantially in accordance with fetched executable computer instructions, such as to manipulate signals and/or states, to construct signals and/or states, etc., with signals and/or states generated in such a manner to be communicated and/or stored in memory, for example.

FIG. 2 also illustrates device 204 as including a component 232 operable with input/output devices, for example, so that signals and/or states may be appropriately communicated between devices, such as device 204 and an input device and/or device 204 and an output device. A user may make use of an input device, such as a computer mouse, stylus, track ball, keyboard, and/or any other similar device capable of receiving user actions and/or motions as input signals. Likewise, for a device having speech to text capability, a user may speak to a device to generate input signals, referred to, for example, as a speaking event. A user may make use of an output device, such as a display, a printer, etc., and/or any other device capable of providing signals and/or generating stimuli for a user, such as visual stimuli, audio stimuli and/or other similar stimuli.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. An apparatus for use in playing a word game that comprises arranging selected physical category labels from a group of physical category labels and/or arranging selected physical subcategory labels from a group of physical subcategory labels to selected positions on a cube-like structure having six cube-like faces, the apparatus comprising:
a cube-like physical structure having six cube-like faces in which a respective cube-like face corresponds with a respective selected topic in a particular arrangement related to a symmetrical structure between the cube-like faces so as to contrast the selected topics in a manner that at least relates to the symmetrical structure between the cube-like faces with respect to the cube-like structure;
one respective cube-like face of the six cube-like faces has a structure of a number of large cells such that the number of large cells are able to be arranged in a square structure on the one respective cube-like face, in which the large cells of the one respective cube-like face respectively have a space for placement of a physical category label in which the selected category comprises a category within the respective selected topic of the one respective cube-like face, and the number of different physical labels for the number of different selected categories within the respective selected topic of the respective one cube-like face corresponds to the number of large cells such that the selected categories are to be arranged in the square structure so as to contrast the different selected categories of the respective selected topic of the one respective cube-like face in a manner that at least relates to the symmetry of the large cell square structure of the one respective cube-like face: one respective large cell of the number of large cells to have a selected physical category label in which the selected category comprises a category within the respective selected topic of the one respective cube-like face, the one respective large cell having a number of small cells arranged in a square structure within the one respective large cell, in which the small cells of the one respective large cell respectively have a space for placement of a physical subcategory label in which the subcategory comprises a subcategory within the selected category of the one respective large cell and the number of different physical labels for the number of different selected subcategories within the respective selected category corresponds to the number of small cells such that the selected subcategories are to be arranged in the square structure so as to contrast the different selected subcategories within the selected category in a manner that at least relates to the symmetry of the small cell square structure of the one respective large cell.

2. The apparatus of claim 1, wherein the symmetry of the large cell square structure of the one respective cube-like face includes horizontal, vertical and/or diagonal symmetry within the one respective cube-like face.

3. The apparatus of claim 1, wherein the symmetry of the small cell square structure within the one respective large cell includes horizontal, vertical and/or diagonal symmetry within the respective large cell.

4. The apparatus of claim 1, wherein the one respective cube-like face comprises a nine by nine small cell square structure with physical labels respectively containing the selected subcategories of the selected categories such that within the nine by nine small cell square structure is formed nine three by three large cell square structures with respect to the selected categories for the one selected topic for the one respective cube-like face, wherein nine selected physical subcategory labels associated within the one selected topic are to be arranged in a particular manner so as to contrast the nine selected subcategories in a manner that at least relates to the horizontal, vertical and/or diagonal symmetry of nine small cells within the respective cube-like face.

5. The apparatus of claim 4, wherein the selected topics of the six faces are arranged in groups of two on opposing corresponding cube-like faces; and wherein the six selected topics in groups of two respectively comprise: My Reality and Another Reality; Knowledge and Influence; and Positive and Negative.

6. The apparatus of claim 5, wherein the cube-like faces have colors associated with the selected topics and, wherein the colors associated with the selected topics comprise: blue for My Reality; red for Another Reality: orange for Knowledge; green for Influence; yellow for Positive; and purple for Negative.

7. The apparatus of claim 5, wherein, for at least one of the two cube-like faces respectively having the selected topics My Reality and Another Reality, the nine category labels comprise: Paradigm, Mind, Character, History, Core, Health, Paradox, Personality and Consume

8. The apparatus of claim 7, wherein, for the cube-like face having the selected topic Knowledge, the nine category labels comprise: Science, Health, History, Math, Philosophy, Technology, Nature, Homo Sapiens, and the Unknown.

9. The apparatus of claim 8, wherein, for the cube-like face having the selected topic Influence, the nine category labels comprise: Institutions, Environment, Nature, Interactions, Emotions, Senses, Influencers, Behavior, and Incentives & Deterrents.

10. The apparatus of claim 9, wherein, for at least one of the two cube-like faces respectively having the selected topics Positive and Negative, the nine category labels comprise: Checks & Balances, Institutions, Protocols, Consume, Core-Values, Environment, Beliefs, People Groups, and Wisdom (Positive selected topic) or Foolishness (Negative selected topic).

11. The apparatus of claim 4, wherein the selected category labels and/or the selected subcategory labels are capable of being physically attached to the cube-like faces in selected patterns on the cube-like faces.

12. The apparatus of claim 11, wherein the selected patterns on the cube-like faces of the selected category labels and/or the selected subcategory labels are capable of being modified to capture at least one particular relationship between the selected category labels and/or the selected subcategory labels that aligns with a spatial symmetry on one or more faces and/or among the one or more faces.

13. The apparatus of claim 4, wherein the physical positions for the selected category labels on a cube-like face comprise: center position, top position, bottom position, left position, right position, and corner positions.

14. The apparatus of claim 13, wherein the corner positions comprise: upper left: upper right: lower left and lower right.

15. The apparatus of claim 4, wherein the physical positions for the selected subcategory labels of a large cell comprise: center position, top position, bottom position, left position, right position, and corner positions.

16. The apparatus of claim 15, wherein the corner positions comprise: upper left; upper right; lower left and lower right.

17. The apparatus of claim 1, wherein the cube-like physical structure comprises at least one of the following materials: any type of one or more polymers, including any compositions thereof, which includes Styrofoam; any type of wood product and/or wood-like materials, including any compositions thereof, which includes cardboard as a wood product; one or more types of metal, including any compositions thereof, which includes alloys; masonry materials, including stone, ceramic, which also includes any compositions thereof; concrete and/or concrete-like materials, including any compositions thereof; glass and/or glass-like products, including any compositions thereof; any one of a number of available solid and/or solidifiable composites, including any combinations thereof; or any compositions of any of the foregoing.

18. The apparatus of claim 1, wherein the physical labels comprise at least one of the following: magnetic material, Velcro material, suction devices, screw-like attachments, attachments capable of being interlocked, transparent plastic sleeves capable of being fixed and/or otherwise attached to a cube-like face, push pins, or any combinations thereof.

19. An article comprising: a non-transitory storage medium;
wherein the storage medium includes stored thereon executable instructions;
wherein the instructions are executable to computer generate six uncombined virtual cube faces that if combined could form a virtual cube;
wherein the instructions are executable to implement a word game that comprises arranging selected virtual category labels from a group of virtual category labels and/or arranging selected virtual subcategory labels from a group of virtual subcategory labels to selected positions on the six virtual faces in which a respective virtual face corresponds with a respective selected topic in a particular arrangement related to a symmetrical structure between the virtual faces so as to contrast the selected topics in a manner that at least relates to the symmetrical structure of the virtual cube that would be formed from combining the uncombined cube faces;
wherein the instructions are further executable to computer generate one respective face of the six faces that has a structure of a number of large cells such that the number of large cells are able to be arranged in a square structure on the one respective face, in which the large cells of the one respective face respectively have a space for placement of a virtual category label in which the category comprises a category within the respective selected topic of the one respective face, and the number of different virtual labels for the number of different categories within the respective selected topic of the respective one face corresponds to the number of large cells such that the categories are to be arranged in the square structure so as to contrast the different selected categories of the respective selected topic of the one respective face in a manner that at least relates to the symmetry of the large cell square structure of the one respective face; and
wherein the instructions are further executable to computer generate one respective large cell of the number of large cells to have a selected virtual category label in which the selected category comprises a category within the respective selected topic of the one respective face, the one respective large cell having a number of small cells arranged in a square structure within the one respective large cell, in which the small cells of the one respective large cell respectively have a space for placement of a virtual subcategory label in which the subcategory comprises a subcategory within the selected category of the one respective large cell and the number of different virtual labels for the number of different subcategories within the respective selected category corresponds to the number of subcategories such that the small cells are to be arranged in the square structure so as to contrast the different selected subcategories within the selected category in a manner that at least relates to the symmetry of the small cell square structure of the one respective large cell.

20. The article of claim 19, wherein the instructions are further executable to computer generate a three-dimensional gaming environment that includes a three-dimensional virtual cube structure in which the six uncombined virtual cube faces are combined to form the three-dimensional virtual cube structure.

21. The article of claim 19, wherein the one respective face comprises a nine by nine small cell square structure with virtual labels respectively containing the selected subcategories of the selected categories such that within the nine by nine small cell square structure is formed nine three by three large cell square structures with respect to the selected categories for the one selected topic for the one respective face, wherein nine selected virtual subcategory labels associated within the one selected topic are to be arranged in a particular manner so as to contrast the nine selected subcategories in a manner that at least relates to the horizontal, vertical and/or diagonal symmetry of nine small cells within the respective face.

22. The article of claim 19, wherein the selected patterns of the selected category labels and/or the selected subcategory labels on the cube faces are capable of being modified to capture at least one particular relationship between the selected category labels and/or the selected subcategory labels that aligns with a spatial symmetry on one or more cube faces and/or among the one or more cube faces.
